(19) United States
(12) Patent Application Publication
(10) Pub. No.: US 2018/0030961 A1
(43) Pub. Date: Feb. 1, 2018

(54) OFFSHORE DEPLOYABLE WIND TURBINE SYSTEM AND METHOD WITH A GRAVITY BASE

(71) Applicant: GAIA IMPORTACAO EXPORTACAO E SERVICOS LTDA, Rio de Janeiro (BR)

(72) Inventors: LUIZ GERMANO BODANESE, Rio de Janeiro (BR); Rafael Louzada BODANESE, Rio de Janeiro (BR)

(73) Assignee: GAIA IMPORTACAO EXPORTACAO E SERVICOS LTDA, Rio de Janeiro (BR)

(21) Appl. No.: 15/219,415

(22) Filed: Jul. 26, 2016

(51) Int. Cl. F03D 13/25; F03D 13/40; F03D 9/30; F03D 13/10; F03D 1/00; F03D 9/00

(52) U.S. Cl. CPC F03D 13/25; F03D 1/001; F03D 1/005; F03D 9/002; F03D 9/30; F03D 13/10; F03D 13/40

(57) ABSTRACT

A method and system for installing a site-deployable wind turbine offshore. The wind turbine can be substantially assembled onshore and includes a gravity base and a tower that is extendable at the installation site. A pivoting system can be configured to couple the wind turbine and turbine blades to the extendable tower in an onsite deployable configuration. After the wind turbine is delivered to an offshore location, the wind turbine is deployed and the extendable base and pivoting system can be made to deploy the wind turbine and turbine blades into functional positions such that the wind turbine can begin generating electricity.

### BACKGROUND

Offshore installation of wind farms has been known for some time. Typically, the installation process for individual wind turbine systems involves a lengthy process in which individual components and/or parts are transported to the offshore site by various cargo ships, barges, and other vessels. Also typical is the need for one or often many crane-carrying ships to be deployed to lift the wind turbine components and parts into the installation position such that the components and parts can be installed. This piecemeal installation process can be cumbersome and take a great deal of time as many different specialized vessels and installation personnel are needed to perform each step of the process. As a result, the installation process can also incur significant financial expenses. Additionally, this has limited the ability to install smaller scale wind farms as the use of these specialized vessels often needs to be for installation in volume. Repair and replacement of individual wind turbines can also be extremely inefficient and costly as the same specialized vessels and specialized personnel need to be shipped to and from the offshore locations of the wind farms.

A typical offshore wind turbine installation project often starts with the installation of heavy concrete and/or metal foundations that may be installed on the sea floor in pre-planned locations. There are many different types of foundations, including specialized foundations that are configured for certain environmental conditions at a given site. These foundations can include heavy pre-fabricated concrete bases, monopile foundations that are inserted into the seabed, and tripod and other similar foundations that may also be inserted into the seabed. After installation of the foundation, towers are typically constructed, the components of the tower being shipped onsite by one vessel and the tower being lifted piece-by-piece into place and attached to the foundation by a crane ship or other specialized vessel having a crane. Next the turbine, which typically includes a drive shaft, transmission, and generator all housed in a nacelle housing, can be lifted into position and attached to the top of the tower. Following this, the turbine blades may be attached to the portion of the drive shaft that extends outwardly from the nacelle housing. Often, each of these components may arrive on different vessels and need to be attached by specialized crane ships or other specialized vessels.

Specially configured cable laying ships can also be deployed to lay electrical lines or install other specialized equipment needed to gather and transmit the power being generated by the turbines. Cable will also often be run to an onshore facility for use of the generated electricity onshore. Depending on the plan for a particular wind farm, the cable running between foundations may be installed before or after the construction of the rest of the wind turbines.

As has been described above, the specialized equipment and skilled personnel needed to install a wind farm can be extensive and costly. Thus, there exists a need for a more efficient offshore deployable wind turbine system and method.

### SUMMARY

To solve the various problems associated with constructing wind turbines and/or wind farms offshore, a new apparatus, method, and system, for installing site-deployable wind turbines offshore has been developed and is described herein. The site-deployable wind turbine described herein can be substantially assembled onshore and includes a gravity base and a tower that is extendable at the installation site. A pivoting system can also be configured to couple the wind turbine and turbine blades to the extendable tower in an on-site and offshore-deployable configuration. The entire system can be substantially assembled onshore, removing many of the logistics issues and/or need for specialized equipment and vessels offshore. After the site-deployable wind turbine is delivered to an offshore location, the site-deployable wind turbine is placed into a resting position such that its gravity base is firmly planted on the seabed. The extendable base and pivoting system can then be articulated such that the wind turbine and turbine blades are placed into their functional positions and the wind turbine can begin generating electricity.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is a side perspective view of an exemplary embodiment of an offshore deployable wind turbine.

FIG. 2 is a top perspective view of an exemplary embodiment of an offshore deployable wind turbine.

FIG. 3 is a side perspective view of an exemplary embodiment of a wind turbine and wind turbine blades.

FIG. 4 is a top perspective view of an exemplary embodiment of a wind turbine and wind turbine blades.

FIG. 5 is a side perspective view of an exemplary embodiment of an offshore deployable wind turbine after installation.

FIG. 6 is a side perspective view of an exemplary embodiment of an offshore deployable wind turbine resting on the sea bed and prior to extension of the turbine tower.

FIG. 7 is an angled side perspective view of an exemplary embodiment of an offshore deployable wind turbine.

FIG. 8 is an angled side perspective view of an exemplary embodiment of an offshore deployable wind turbine during extension of the turbine tower.

FIG. 9 is an angled side perspective view of an exemplary embodiment of an offshore deployable wind turbine during extension of the turbine tower.

FIG. 10 is a side perspective view of an embodiment of an offshore deployable wind turbine in a buoyant configuration being transported to an installation site by a ship.

FIG. 11 is a side perspective view of an embodiment of offshore deployable wind turbines being transported in an alternative configuration to an installation site on a ship.

FIG. 12 is a top perspective view of an embodiment of offshore deployable wind turbines being transported to an installation site on a ship, as also shown in FIG. 11.

FIG. 13 is a side perspective view of an alternative embodiment of an offshore deployable wind turbine configured having a gravity base configured with divided cellular structures and a skirt added to provide stability to the structure if the soil characteristics require.

FIG. 14 is a side perspective view of an embodiment of an offshore deployable wind turbine showing each step of deployment once at the installation site.

FIG. 15 is a side perspective view of an alternative embodiment of an offshore deployable wind turbine configured having a gravity base with divided cellular structures and labeled with one possible configuration of materials that may be placed in the cellular structures.

FIG. 16 is a side perspective view of an alternative embodiment of an offshore deployable wind turbine configured having a floating structure with divided cellular structures and labeled with one possible configuration of materials that may be placed in the cellular structures and one possible anchoring configuration.

FIG. 17 is a top perspective view of an alternative embodiment of an offshore deployable wind turbine configured having a floating structure and shown with one possible anchoring configuration, which can be modified according to environmental condition, such as wind, currents and wave patterns that may be present at a specific installation location.

FIG. 18 is a side perspective view of an alternative embodiment of an offshore deployable wind turbine configured with helical strakes.

### DETAILED DESCRIPTION

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein. Further, it should be understood that any feature of one embodiment disclosed herein can be combined with one or more features of any other embodiment that is disclosed, unless otherwise indicated.

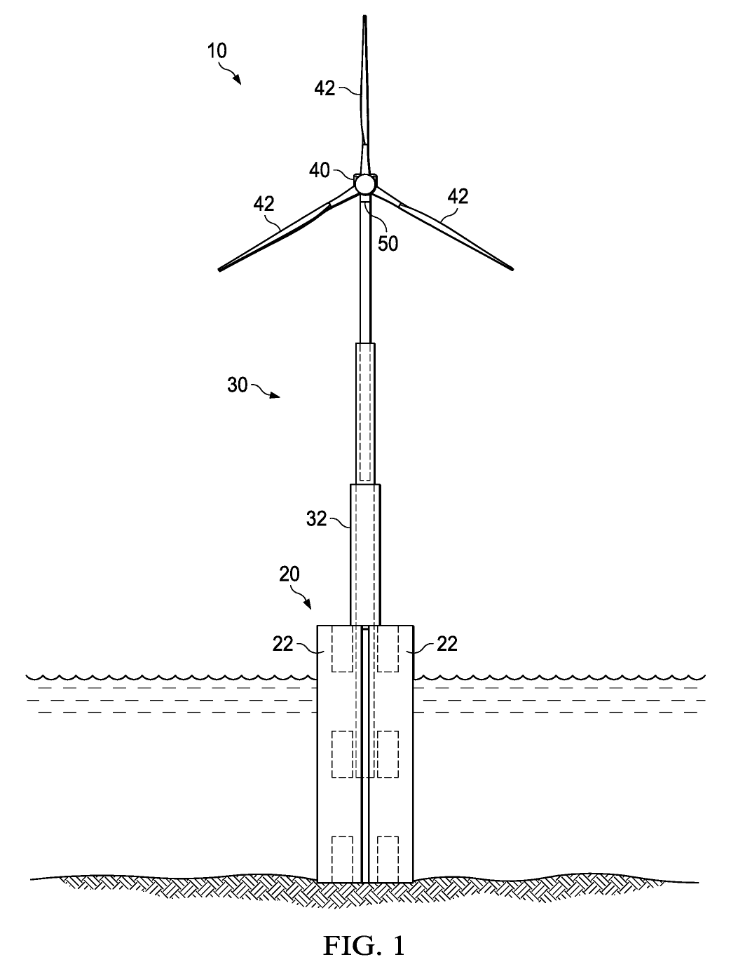

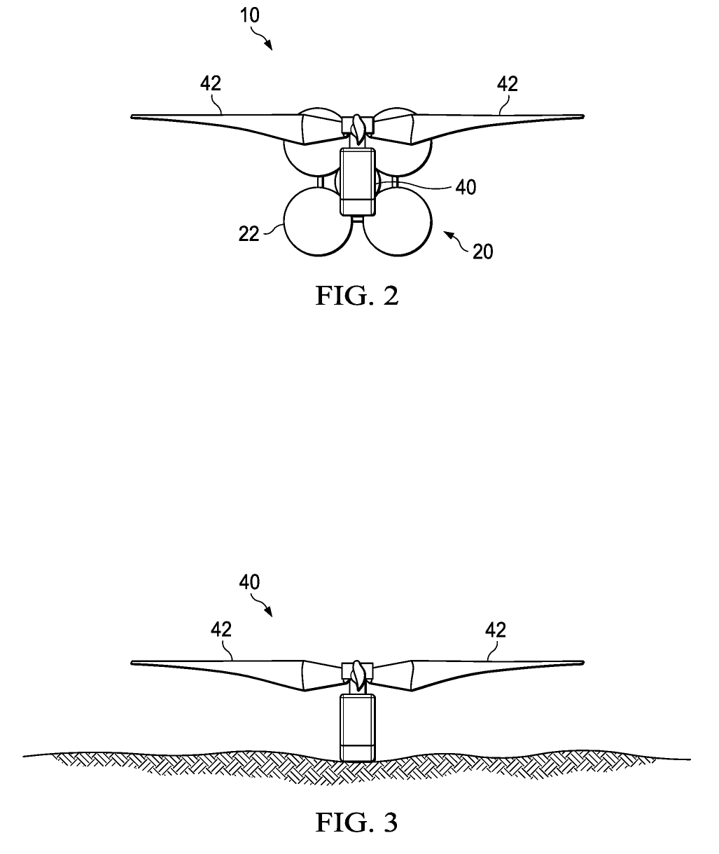

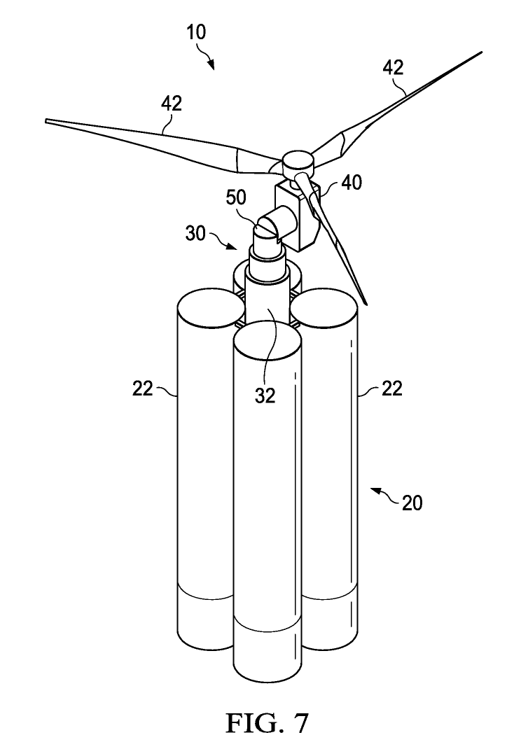

As illustrated in FIG. 1 and FIG. 2 and as described in detail below, an embodiment of an offshore deployable wind turbine system 10 can be configured with a self-installable gravity base 20 to install the wind turbine on the sea bed or in other wetland areas on or offshore having adequate water depth, e.g. from 10 m to 40 m depth, though systems of varying dimensions may also be constructed to accommodate shallower or deeper waters. In an embodiment, the gravity base 20 can be constructed onshore and can be configured with an extendable tower 30. While the extendable tower 30 is retracted and still onshore, the wind turbine 40 and its blades 42 can be mounted on top of the extendable tower 30 utilizing harbor or industrial infrastructure such as cranes. In an embodiment, the wind turbine 40 can be configured to include a drive shaft, transmission, generator, and other associated components. Optionally, a brake assembly and/or yaw adjustment components can also be included. Typically, each of these components will be configured in a nacelle housing, with a portion of the drive shaft extending outside of the housing such that the wind turbine blades 42 can be connected to the wind turbine 40. In an embodiment, the uppermost part of the extendable tower 30 can be configured with a pivoting system 50 (pivoting system 50 is shown and described in greater detail in relation to FIG. 7) which allows the wind turbine 40 to initially be installed on its vertical axis, such that any configured wind turbine blades would be approximately parallel with the ground. This allows for the wind turbine blades 42 to be installed while the offshore deployable wind turbine system 10 is still onshore. When the relative height from the top of the extendable tower 30 to the ground allows, the pivoting system 50 can then be utilized so that wind turbine 40 can be positioned with its wind turbine blades 42 in the horizontal or working position.

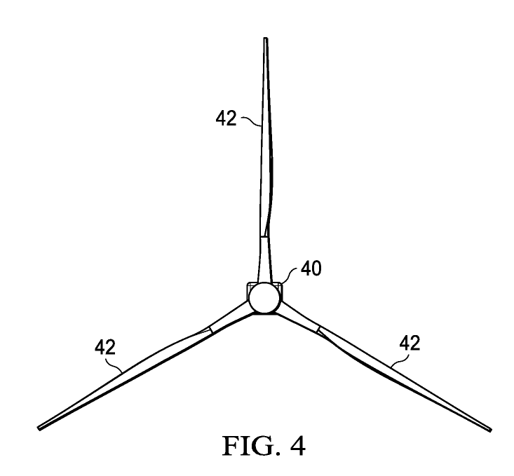

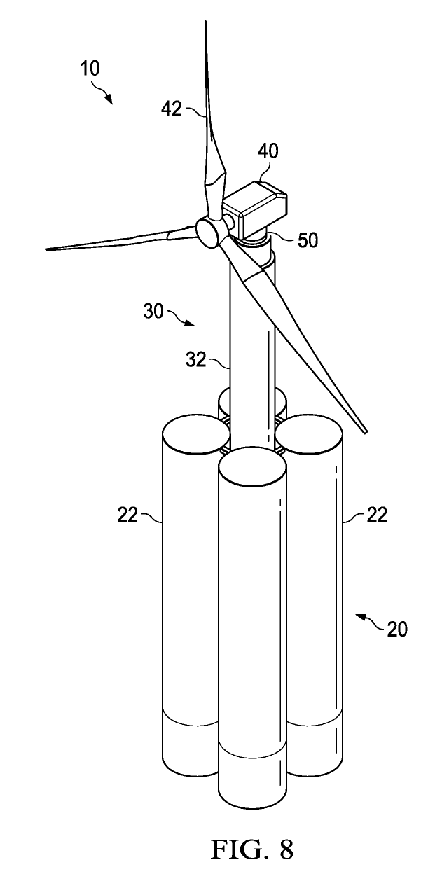

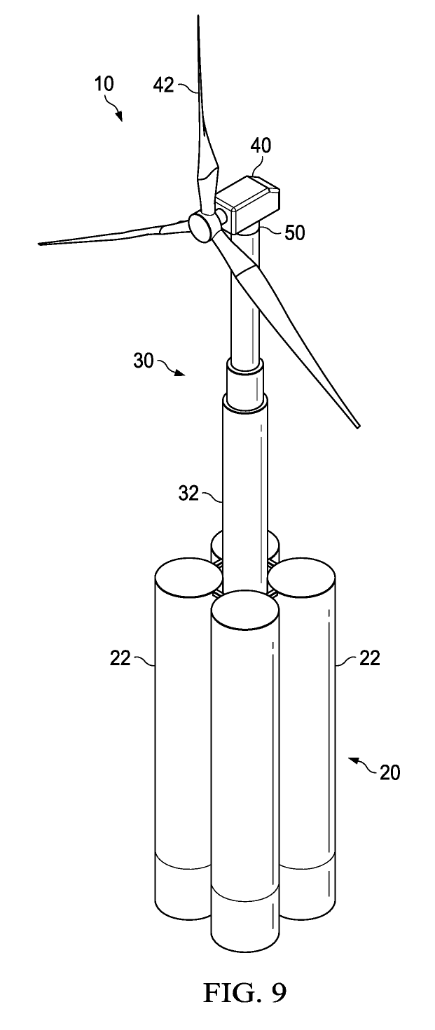

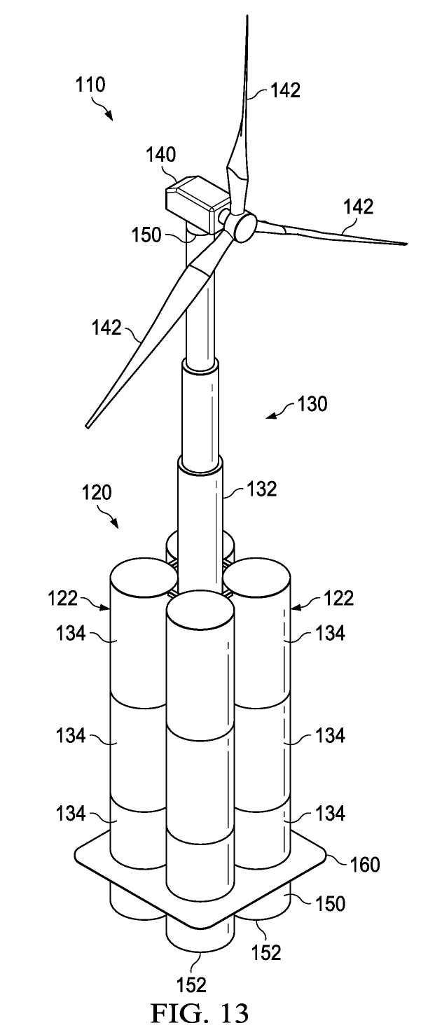

In an embodiment, the gravity base 20 can be configured to have its own buoyancy during transport and then be employed as a gravity base, keeping the entire wind turbine in position once deployed. In such a configuration the buoyancy of the gravity base 20 may be produced by a network of cellular structures 22 (cylinders as depicted in FIGS. 1 through 9) that are structurally connected forming the hull of the gravity base 20. The shape of the cellular structures 22, as well as the diameter and length of the structures may vary according the desired configuration for a given installation site. The lower part of the hull may also be configured with a skirt (as shown in the embodiment illustrated by FIG. 13) in order to penetrate the seabed at the installation site, thus providing additional stability. The upper portion of the gravity base 20 can also be configured with a deck (not shown) to allow personnel access to the extendable tower system 30 or alternatively a structure similar to the skirt shown in FIG. 13 could also be configured as a deck for personnel.

An embodiment of this system allows for the wind turbine and the wind turbine blades to be assembled on ground with the rotating axis in a vertical position as shown in FIG. 3. This allows for the assembly operation to be performed onshore rather than offshore, as is the case with traditional systems. Once the blades are attached to the turbine, the system may be lifted to and installed on top of the extendable tower 30. Further, in an embodiment, a pivoting system 50 can be configured at the top of the extendable tower 30, and in this configuration the wind turbine 40 will be attached to the pivoting system 50 or both the pivoting system 50 and the extendable tower 30, depending on the particular configuration.

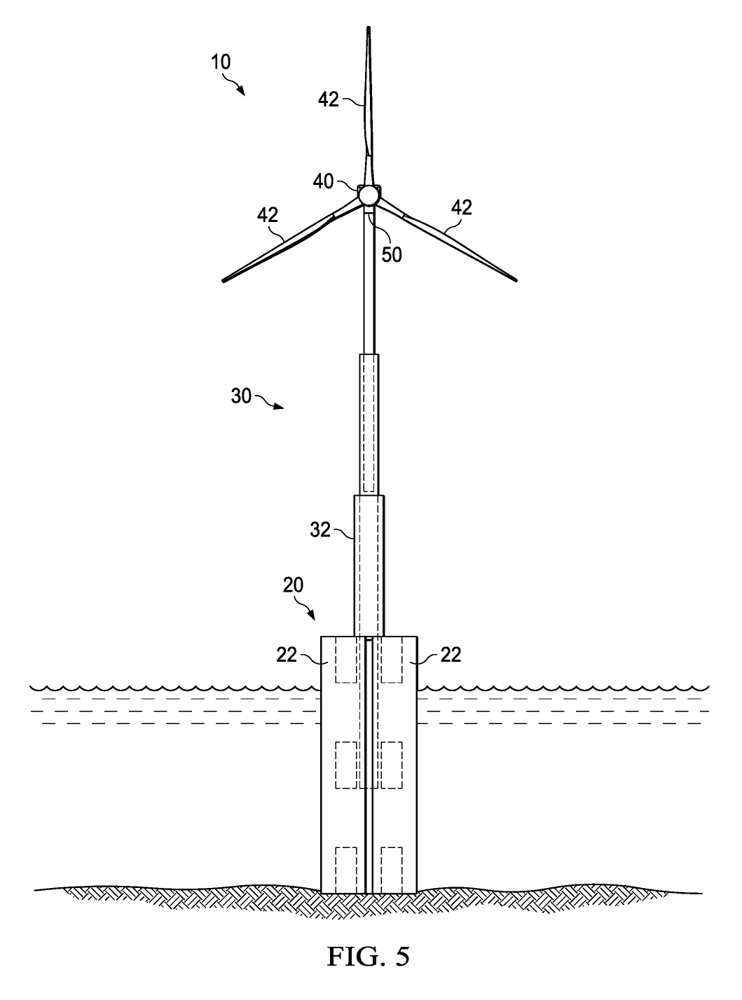

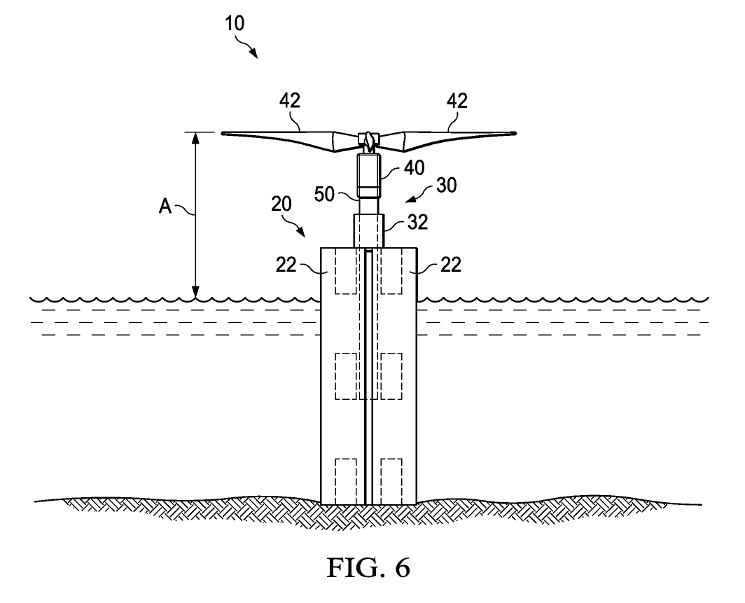

In an embodiment, the connection between the extendable tower 30 and the wind turbine 40 may include a pivoting or articulation system 50 that allows the turbine 40 to rotate from the normal working position, as illustrated in FIG. 5, to the position with the axis on the vertical, as illustrated in FIG. 6, thus allowing a 90 degree inclination around the pivoting axle. This pivoting system 50 may be activated using conventional hydraulic or mechanical systems such as hydraulic cylinders or gears activated by electric motors.

In an embodiment, the pivoting system 50 may be used during transport and/or installation of the wind turbine system 10 when the height of wind turbine system 10 is not sufficient to prevent the blades 42 from touching the water or ground. The pivoting system 50 can also be used for maintenance, such as to repair the wind turbine system components, wind turbine blades 42, or for decommissioning of the wind turbine system 10.

In an embodiment, and as illustrated in FIGS. 1-9, the extendable tower 30 can be made of a number of concentric cylinders 32 that might be extended (or activated) by various methods. In an embodiment, extendable tower 30 may include two or three concentric cylinders 32, but it may also include more, depending on the desired configuration. In an embodiment, to facilitate the extension of the cylinders, water may be injected in the annulus of the cylinders, which may be dry and empty during transport. In an alternative configuration, the cylinder may be extended (or activated) by emptying the cylinder annulus which is initially flooded. In any activating method, the concentric cylinders are extended vertically and may further be connected structurally (e.g. by welding, or connecting and securing sections mechanically using bolts or other methods) in order to create a rigid tower to support the wind turbine system.

In an embodiment of the extendable tower system 30, concentric cylinders are utilized in the same way as conventional hydraulic systems, that is, a liquid may be pumped with high pressure to the interior of the cylinder causing an axial force which pushes an internal piston. The piston pushed by the internal pressure in the external cylinder (liner) is the section of the tower that will be extended. After completing the extension, welding or other types of structural connections may be made at the connection between each internal cylinder) and each external cylinder). This procedure may be repeated to the subsequent sections of the tower until the tower reaches its operating height.

Optionally, and similar to the configurations described in the previous paragraphs, it is possible to configure the wind turbine and the blades on a pivoting base in a way that facilitates the transport to an installation site with the wind turbine system configured in this manner.

In an embodiment, at the installation location, with the help of a compressor, air is injected into the internal cylinder that forms the telescopic tower. The air will displace the water and reduce the cylinder weight, thus extending the tower 30 and raising the wind turbine 40 and wind turbine blades 42. In case the wind turbine 40 is transported with its rotor axis in the vertical position, the wind turbine 40 and wind turbine blades 42 can be rotated using the pivoting system 50 to put the wind turbine 40 into the operating position.

In an embodiment, if the cylinder does not have enough buoyancy to raise the rotor to the desired height, a second installation support device can be employed to provide the necessary elevation. Such a device may be composed of two identical concentric cylinders with a closed annulus at the top section. In this configuration, the cylinders will be initially flooded and will have compressed air injected in the annulus to promote buoyancy and consequently elevation. This device will be assembled around the pool of cylinders and will form the extendable tower.

Once the internal cylinder reaches the desired height, it may be integrated with the external cylinder in a manner creating a waterproof connection. The installation support device is then retracted to its original position by relieving the pressure of the compressed air in the annulus. The device may also be fixed to the external cylinder. Compressed air is then injected into the device and into the tower cylinder. The turbine is then moved to a higher position.

The process above is repeated as many times as necessary so that the extendable tower has its sections completely elevated and the wind turbine reaches its operating position.

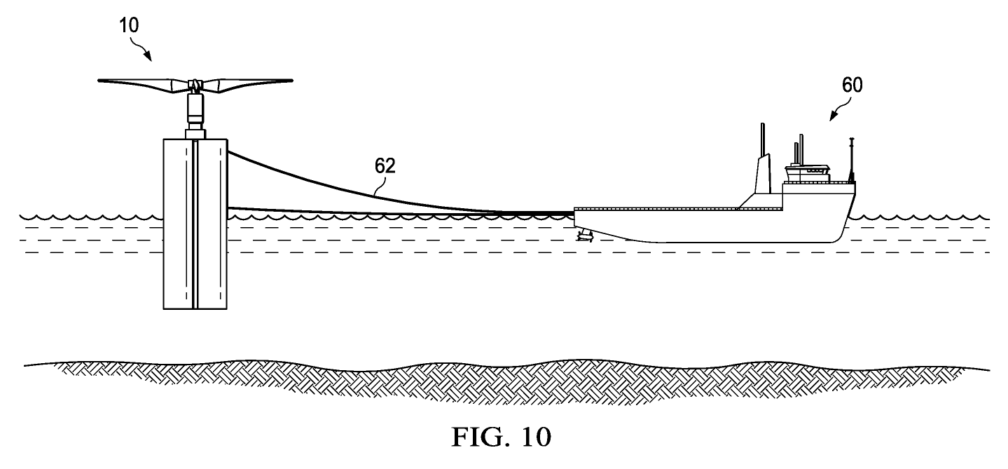

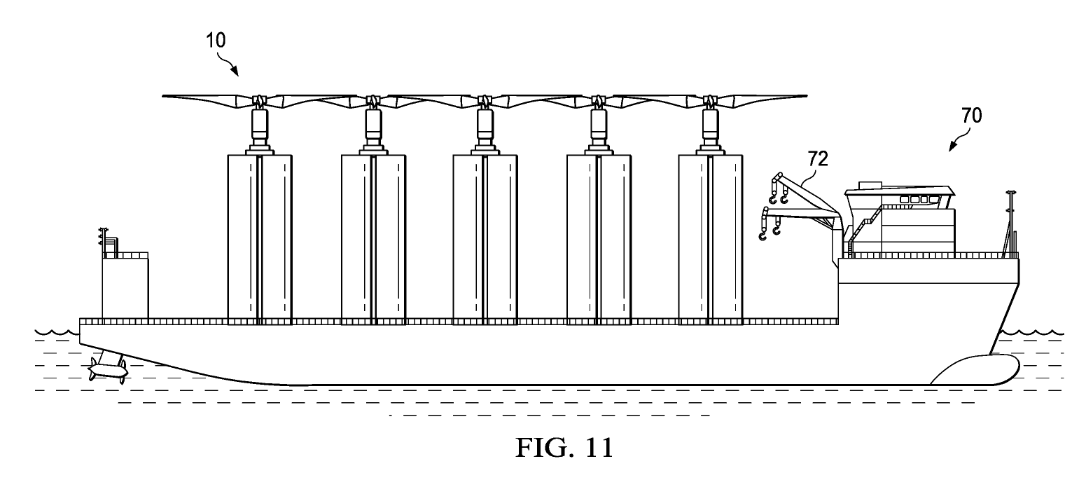

FIG. 10 illustrates one possible transportation method for an offshore deployable wind turbine system 10. In this embodiment the deployable wind turbine system 10 is configured to be buoyant and float while being towed behind a ship 60 or other vessel. A high tensile strength cable 62 or rope can be configured between the turbine system 10 and ship 60, such that the turbine system 10 is towed behind the ship 60. One or multiple turbine systems 10 may be towed behind a ship 60 at a given time.

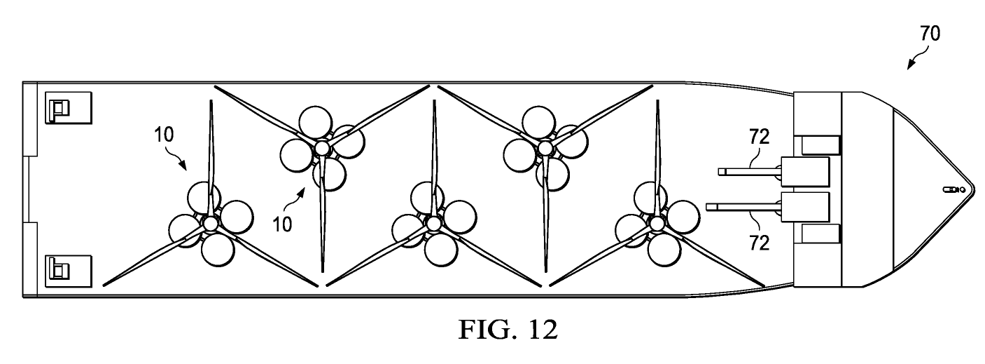

FIG. 11 and FIG. 12 illustrate an alternative transportation possibility where multiple deployable wind turbine systems 10 can be transported to the installation site on a transportation ship 70 or other suitable vessel. In this embodiment, the transportation ship 70 may also be configured with one or more optional cranes 72 to assist in loading and unloading the deployable wind turbine systems 10 at the dock and installation site.

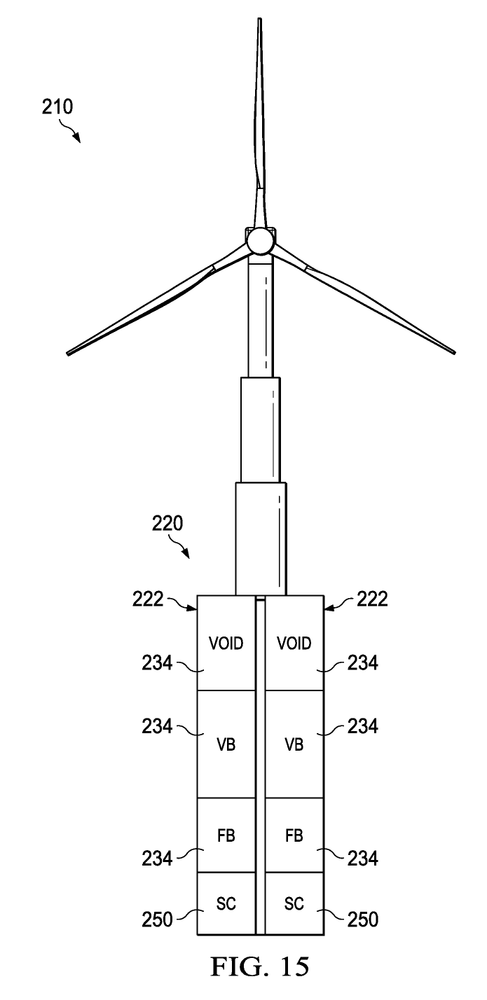

FIG. 13 illustrates an alternative embodiment of an offshore deployable wind turbine system 110, shown configured with a self-installable gravity base 120 comprising cellular structures 122, an extendable tower 130 comprising concentric cylinders 132, wind turbine 140, and wind turbine blades 142. This embodiment can also optionally be configured with a pivoting system 150. This alternative embodiment includes additional features regarding the gravity base 120. In this embodiment, cellular structures 122 can each include a plurality of inner cavities 134 which can be filled with various materials depending on the configuration desired for installation and/or the installation site (see FIG. 15 and description regarding FIG. 15 below for additional details regarding possible filler materials for the inner cavities). An optional skirt 160 can also be configured on this or other embodiments of the wind turbine systems described herein. In addition, optional lower base 150 can be included, which may comprise hollow cylinders 152 which are open on the bottom and therefore can be embedded into the sea floor. Optional skirt 160 can then serve to stabilize the lower base 150 on the sea floor.

Further, in an embodiment, the height of an offshore deployable wind turbine system can be highly configurable. The cellular structures that form the gravity base of a given embodiment can be varied in height and customized for a given installation site. Further, height can be added or removed from a particular gravity base by lengthening or reducing the length of the cellular structures of a deployable wind turbine system. These cellular structures can be welded or cut to provide custom installation heights to meet the needs of a particular installation location.

In another alternative embodiment (not shown), an offshore deployable wind turbine can be installed in the buoyant state and connected to the sea floor with cables or anchors.

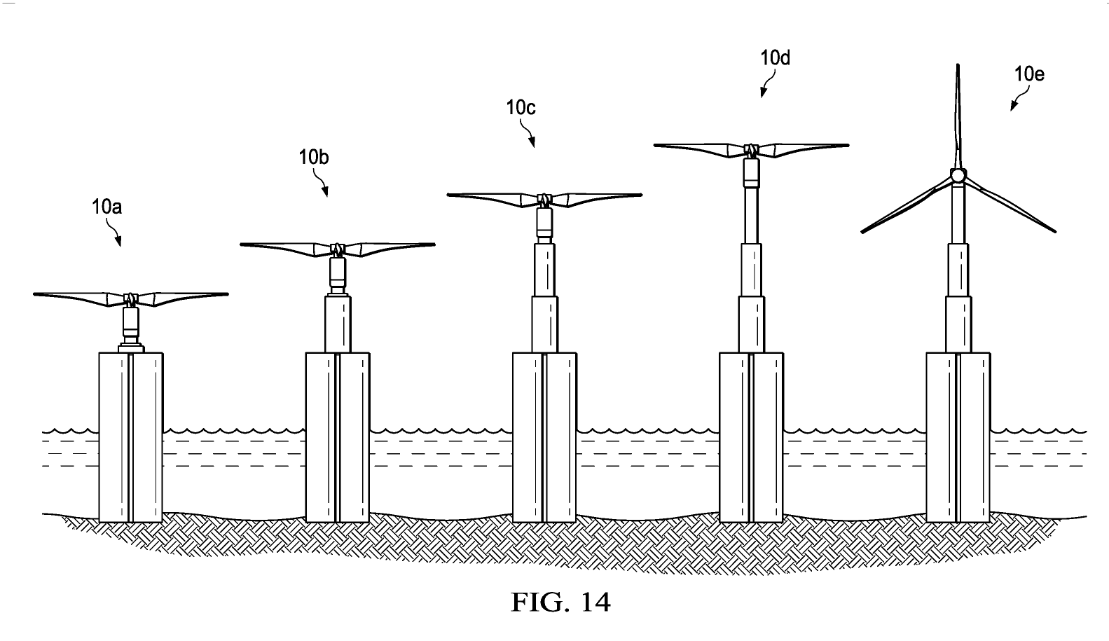

FIG. 14 is a side perspective view of an embodiment of an offshore deployable wind turbine showing exemplary steps of deployment once at the installation site. Offshore deployable wind turbine 10a shows an example of initial deployment on the sea floor. Offshore deployable wind turbine 10b shows an example of initial deployment on the sea floor where the extendable tower has started to raise the turbine. Offshore deployable wind turbine 10c shows an example of initial deployment on the sea floor where multiple concentric cylinders of the extendable tower are deployed. Offshore deployable wind turbine 10d shows an example of initial deployment on the sea floor where the extendable tower is fully raised. Offshore deployable wind turbine 10e shows an example of initial deployment on the sea floor where the extendable tower is fully raised and the turbine has been pivoted into a functional position.

FIG. 15 illustrates an alternative embodiment of an offshore deployable wind turbine system 210, shown configured with a self-installable gravity base 220 configured with cellular structures 222, which can each include a plurality of inner cavities 234 which can be filled with various materials depending on the configuration desired for installation and/or the installation site. Within one particular cellular structure 222, inner cavities 234 may be separated from each other by placing a steel plate or other physical barrier across the inner diameter of cellular structure 222 at the desired location. It should be noted that the number of inner cavities 234 may differ from what is illustrated in FIG. 15. Further, the gravity base can also be configured as a plurality of rectangular containers, one large rectangular container having a hollow center section, one large cylinder having a hollow center section, or other configurations. Each of these possible configurations can further be subdivided to have multiple inner cavities similar to the embodiment illustrated in FIG. 15. The materials that can be placed in the individual cavities may include various materials. For example. the lowermost of the inner cavities 234 may contain hematite or concrete to help anchor a deployable wind turbine system 210. The next inner cavities up from the sea floor may be filled with water, and the uppermost inner cavities may be filled with air for buoyancy or simply be a void space that does not need to be filled. Each of these sections can either be filled during construction, at the dock, during transport, or at the installation site and the filler material can be customized for a particular installation site. The lower base 250 can be configured as hollow with an open bottom to be inserted into the sea floor or it can optionally be sealed and filled with concrete or other material depending on the particular installation site.

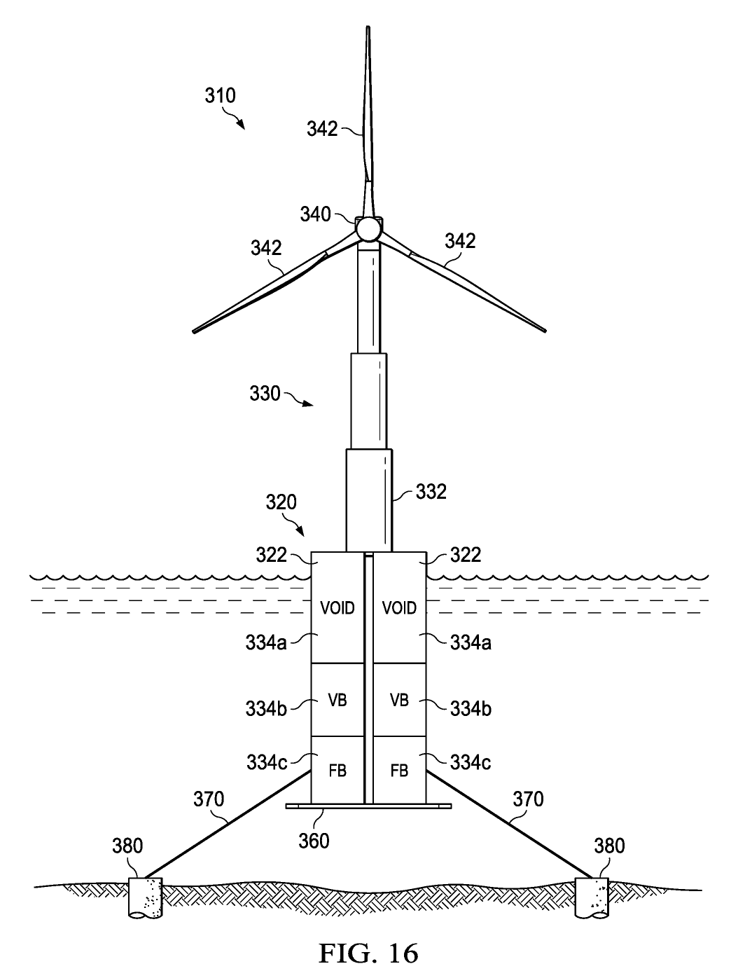

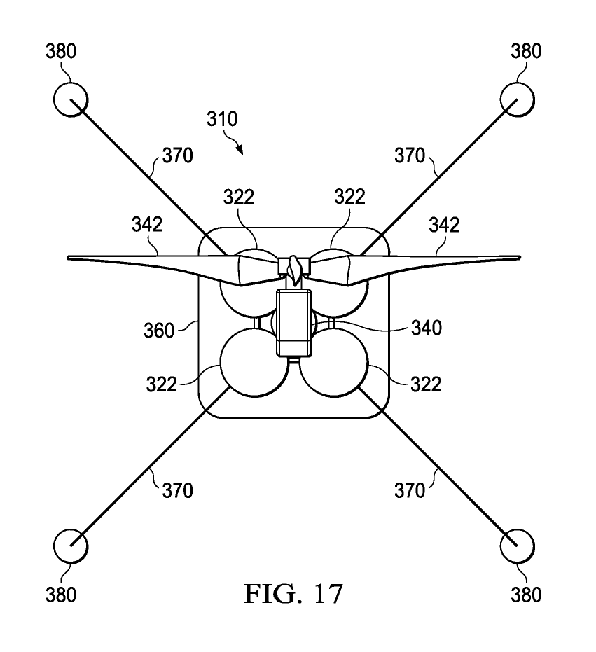

FIGS. 16 and 17 illustrate alternative embodiments of an offshore deployable wind turbine 310 configured having a floating structure 320 with divided cellular structures 322 and labeled with one possible configuration of materials that may be placed in the cellular structures 322 and one possible anchoring configuration that includes cables 370 and anchors 380 to the sea floor. This embodiment may further include an extendable tower 330 comprising concentric cylinders 332, a wind turbine 340, and wind turbine blades 342. This embodiment can also optionally be configured with a pivoting system 350. In this embodiment, the divided cellular structures 322 can each include a plurality of inner cavities 334a, 334b, and 334c, which can be filled with various materials depending on the configuration desired for installation and/or the installation site. Here uppermost inner cavity 334a is shown as a void space that may contain air to make the deployable wind turbine 310 buoyant. The uppermost inner cavity 334a can also be referred to as void tanks (“VOID”) which can further be configured to be closed and sealed in a manner that they will provide sufficient buoyancy to the structure during installation and such that they will continue to provide buoyancy during the operational life of the structure. Middle inner cavity 334b, the first section below the void tanks, can also be referred to as variable ballast tanks (“VB”) and may be filled with water such that buoyancy can be added or subtracted from the structure by increasing or decreasing the amount of water inside the variable ballast tanks or middle inner cavity 334b. The first section below the variable ballast tanks 334b are the lowermost inner cavity or fixed ballast tanks (“FB”) 334c. The fixed ballast tanks 334c may be filled with hematite or concrete as to provide additional mass at the lower portion of the structure and increase its intrinsic stability. Other materials similar to hematite or concrete may also be used to fill the fixed ballast tanks 334c. Additionally, an optional heave plate 360 can be configured, similar to the skirt 160 configured with respect to FIG. 13, but in this configuration, the heave plate can provide a damping effect over vertical movements of the floating gravity base 320.

Referring to FIG. 17, cables 370 and anchors 380 can be configured in a cross pattern as shown, or in an alternative embodiment more or less cables and anchors may be used to keep the offshore deployable wind turbine 310 in position.

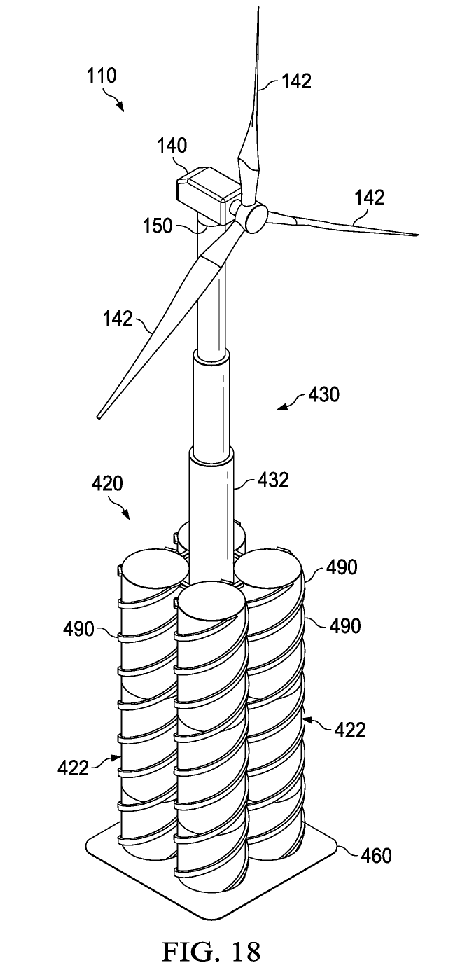

FIG. 18 illustrates another alternative embodiment of an offshore deployable wind turbine 410 which can be configured to either be a floating or non-floating (fixed on the sea bed floor) embodiment, as described in more detail above. Either embodiment may further include helical strakes 490. Helical strakes 490 may be formed of any suitable material, including but not limited to steel, plastic, or polyurethane. Helical strakes 490 may be welded or clamped to the cells of the gravity base or floating structure and can follow a spiral path around the gravity base 460. The strakes will typically be added during manufacturing or assembly onshore. In general, the helical strakes 490 can help prevent vortex induced vibration which may occur when the offshore deployable wind turbine is moved through the water causing laminar flow to transition to turbulent flow, or during operation when currents pass through the offshore deployable wind turbine. In the case of the gravity base 460, the cylindrical structures can cause the outer part of the fluid flowing by to have a higher speed that the internal fluid, which in turn can generate a difference in pressure and cause an alternating vortex and turbulence.

In a helical strake embodiment of the offshore deployable wind turbine, the pitch of the helix can be adjusted depending on the project to maximize the reduction in vortex induced vibration. The diameter of the cellular structures that make up the gravity base can also be configured to reduce vortex induced vibration.

1. An offshore deployable wind turbine system, comprising:
a gravity base,
an extendable tower system coupled to the gravity base,
a wind turbine comprising a drive shaft, transmission, and generator, configured in a nacelle housing,
a plurality of turbine blades connectable to said drive shaft, and
a pivoting system coupling the wind turbine to the extendable tower system.

2. The offshore deployable wind turbine system of claim 1, wherein the gravity base comprises a plurality of cellular structures which are structurally connected to form a hull of the gravity base configured to be fixed in the soil of the sea floor.

3. The offshore deployable wind turbine system of claim 2, wherein the plurality of cellular structures are cylindrical in shape.

4. The offshore deployable wind turbine system of claim 2, wherein helical strakes are connected to the plurality of cellular structures.

5. The offshore deployable wind turbine system of claim 2, wherein the plurality of cellular structures are cubical in shape.

6. The offshore deployable wind turbine system of claim 2, wherein each of the plurality of cellular structures are substantially uniform in shape and dimensions.

7. The offshore deployable wind turbine system of claim 2, wherein the plurality of cellular structures are subdivided as follows:
the top section of each cellular structure is a void tank containing ambient air, compressed air, or other gaseous material;
the section of each cellular structure immediately below the void tank is a variable ballast tank that is filled at least in part with water;
the section of each cellular structure immediately below the variable ballast tank is a fixed ballast tank that is filled at least in part with hematite or concrete; and
the section of each cellular structure immediately below the fixed ballast tank is a suction can that is fixed in the soil of the sea floor.

8. The offshore deployable wind turbine system of claim 1, wherein the extendable tower system comprises a plurality of concentric cylindrical structures.

9. An offshore deployable wind turbine system, comprising:
a gravity base,
an extendable tower system coupled to the gravity base,
a wind turbine comprising a drive shaft, transmission, and generator, configured in a nacelle housing, and
a plurality of turbine blades connectable to said drive shaft.

10. The offshore deployable wind turbine system of claim 9, wherein the gravity base comprises a plurality of cellular structures which are structurally connected to form a hull of the gravity base configured to be fixed in the soil of the sea floor.

11. The offshore deployable wind turbine system of claim 10, wherein the plurality of cellular structures are cylindrical in shape.

12. The offshore deployable wind turbine system of claim 10, wherein helical strakes are connected to the plurality of cellular structures.

13. The offshore deployable wind turbine system of claim 10, wherein the plurality of cellular structures are cubical in shape.

14. The offshore deployable wind turbine system of claim 10, wherein each of the plurality of cellular structures are substantially uniform in shape and dimensions.

15. The offshore deployable wind turbine system of claim 10, wherein the plurality of cellular structures are subdivided as follows:
the top section of each cellular structure is a void tank containing ambient air, compressed air, or other gaseous material;
the section of each cellular structure immediately below the void tank is a variable ballast tank that is filled at least in part with water;
the section of each cellular structure immediately below the variable ballast tank is a fixed ballast tank that is filled at least in part with hematite or concrete; and
the section of each cellular structure immediately below the fixed ballast tank is a suction can that is fixed in the soil of the sea floor.

16. The offshore deployable wind turbine apparatus of claim 9, wherein the extendable tower system comprises a plurality of concentric cylindrical structures.

17. A method of installing an offshore deployable wind turbine system, comprising the following steps:
providing a deployable wind turbine system comprising:
a gravity base,
an extendable tower system coupled to the gravity base,
a wind turbine comprising a drive shaft, transmission, and generator, configured in a nacelle housing,
a plurality of turbine blades connectable to said drive shaft, and
a pivoting system coupling the wind turbine to the extendable tower system;
anchoring the gravity base of the wind turbine system on a sea bed;
pivoting the pivoting system of the wind turbine system such that the wind turbine and turbine blades are in a functional position once the extendable tower system is extended;
extending the extendable tower system, thereby lifting the wind turbine and plurality of turbine blades higher above the gravity base.

18. The offshore deployable wind turbine system of claim 17, wherein the gravity base comprises a plurality of cellular structures which are structurally connected to form a hull of the gravity base configured to be fixed in the soil of the sea floor.

19. The offshore deployable wind turbine system of claim 18, wherein the plurality of cellular structures are cylindrical in shape.

20. The method of installing an offshore deployable wind turbine system of claim 18, wherein helical strakes are connected to the plurality of cellular structures.

21. The method of installing an offshore deployable wind turbine system of claim 17, wherein the extendable tower system comprises a plurality of concentric cylindrical structures.

22. The method of installing an offshore deployable wind turbine system of claim 21, further comprising the following steps:
hydraulically pumping fluid or compressing air into an inner cavity of the plurality of concentric cylindrical structures such that one or more of the plurality of concentric cylindrical structures deploy upwardly into functional positions.

23. The method of installing an offshore deployable wind turbine system of claim 21, further comprising the following steps:
mechanically attaching each of the concentric cylindrical structures to each other.

24. The method of installing an offshore deployable wind turbine system of claim 18, wherein the plurality of cellular structures are subdivided as follows:
the top section of each cellular structure is a void tank containing ambient air, compressed air, or other gaseous material;
the section of each cellular structure immediately below the void tank is a variable ballast tank that is filled at least in part with water;
the section of each cellular structure immediately below the variable ballast tank is a fixed ballast tank that is filled at least in part with hematite or concrete; and
the section of each cellular structure immediately below the fixed ballast tank is a suction can that is fixed in the soil of the sea floor.
